(19) United States
(12) Patent Application Publication
(10) Pub. No.: US 2008/0264977 A1
(43) Pub. Date: Oct. 30, 2008

(54) Spray bottle and mechanism operable to disperse liquid when in an upright or an inverted orientation

(76) Inventor: Pamela Moudgill, Hockessin, DE (US)

Correspondence Address: Raymond M. Galasso;Galasso & Associates LP, P.O. Box 26503, Austin, TX, 78755-0503, US

(21) Appl. No.: 11/796,478

(22) Filed: Apr. 27, 2007

(51) Int. Cl. B67D 5/40

(52) U.S. Cl. 222/376

(57) ABSTRACT

A bottle configured to dispense a liquid disposed therein upon the bottle being oriented in a generally upright or inverted manner. The bottle includes a reservoir configured to receive and store a liquid therein. Proximate the opening of the reservoir a pump head including nozzle are releasably secured thereto. An extraction tube has a first end operably connected to the pump head and a second end substantially disposed within the reservoir. The second end of the extraction tube has a first and second portion being of different lengths for assisting in the retrieval of the liquid disposed within the reservoir. An actuating lever is operably connected to the extraction tube. Valves are connected to the extraction tube to facilitate the operation of the bottle in either of the upright or inverted positions.

### FIELD OF THE INVENTION

The present invention relates to a liquid dispensing device, more specifically a liquid dispensing bottle that is configured to dispersed the liquid disposed therein in either an upright position or and inverted position.

### BACKGROUND

Thousands of different liquid products are utilized by people on a daily basis and are commonly dispensed utilizing a pump spray bottle. Products ranging from hairspray to car cleaning products all utilize a conventional spray bottle that includes an actuating lever to draw liquid from a bottle and discharge the liquid through a nozzle.

One problem with conventional spray bottle is that typically a single tube or pipe is disposed within a reservoir or bottle that is operably connected to a small pump and an actuating lever that functions discharge the liquid through the nozzle and then draw the liquid into the pipe. These conventional spray bottles utilize a tube or pipe that extends substantially into the reservoir but not all the way in order to avoid having the end of the tube contact the bottom of the reservoir in order for the conventional spray bottle to function. During use of this type of conventional spray bottle, a user will be unable to extract all of the liquid disposed within the reservoir as the pipe does not extend to the bottom thereby leaving a portion of the liquid proximate the bottom in the reservoir.

Another problem when utilizing a conventional spray bottle is that a user can not extract the liquid disposed therein subsequent to the bottle being oriented into an inverted position. Some applications require that a user invert the conventional spray bottle to direct the liquid to the desired location. Subsequent to inverting the bottle, the liquid shifts proximate the top portion of the bottle and the rigid extraction pipe is proximate the bottom thereby being unable to extract liquid from the reservoir.

Accordingly, there is a need for a spray bottle that can substantially extract liquid from the reservoir regardless of the position of the spray bottle.

### SUMMARY OF THE INVENTION

It is the object of the present invention to provide a spray bottle that can disperse liquid contained therein subsequent to the spray bottle being oriented in an inverted position.

Another object of the present invention is to provide a spray bottle that can disperse liquid contained therein that is configured with an extraction tube with two extraction ends.

A further object of the present invention is to provide a spray bottle that can extract substantially all of the liquid contained therein.

An additional object of the present invention is to provide a spray bottle that can disperse liquid contained therein subsequent to being oriented in an inverted position that is relatively inexpensive.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawing wherein:

FIG. 1 illustrates a preferred embodiment of the present invention illustrated in an upright position; and

FIG. 2 illustrates a preferred embodiment of the present invention illustrated in an inverted position.

### DETAILED DESCRIPTION

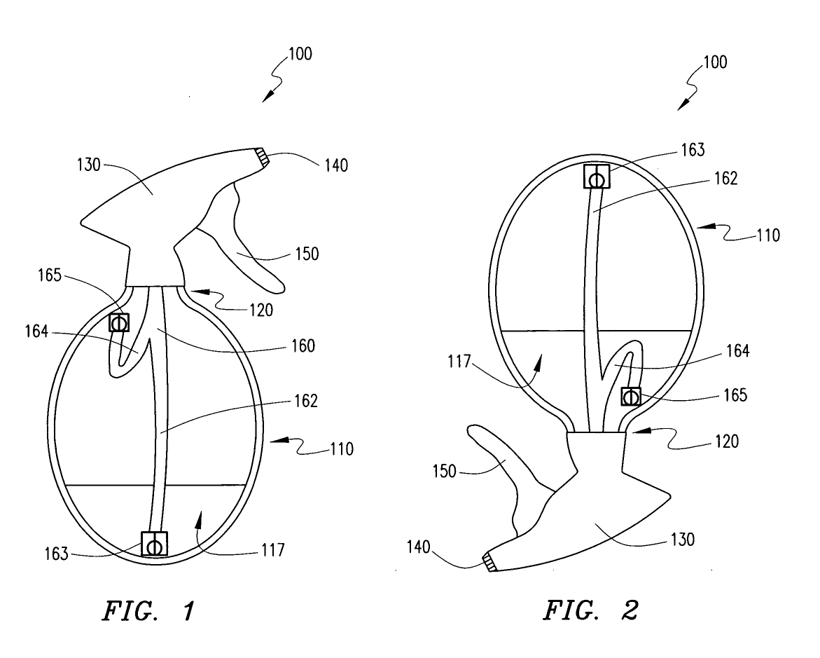

Referring now to the drawings submitted herewith wherein the various elements depicted therein are not necessarily drawn to scale and wherein like elements are designated with like reference numerals throughout the figures and in particular FIGS. 1 and 2, there is illustrated a preferred embodiment of a spray bottle system 100 constructed according to the principles of the present invention.

The spray bottle system 100 includes a bottle 110 with a pump head 130 connected thereto. An extraction tube 160 is connected to pump head 130 and inserted into bottle 110.

Bottle 110 includes a reservoir 117 that functions to store a desired liquid for subsequent dispersal. Bottle 110 is manufactured from a suitable durable material such as but not limited to plastic, glass, or metal. Although bottle 110 is illustrated in the drawings submitted herewith as being substantially oval in shape, it is contemplated within the scope of the present invention that bottle 110 could be manufactured in a plurality of different shapes. At end 120 of bottle 110, it is contemplated that bottle 110 be configured with a securing mechanism to be able to secure pump head 130 to bottle 110. Such would include, but not be limited to, integrated threads on bottle 110 and mating threads on pump head 130.

Pump head 130 is a typical pump head for a spray bottle and includes spray nozzle 140, trigger 150, and contains a trigger activated pump therein.

Extraction tube 160 is connected to pump head 130 and is disposed within the reservoir 117 of bottle 110. The extraction tube 160 functions to provide an egress for the liquid disposed within the reservoir 117. The extraction tube 160 facilitates the retrieval of the liquid disposed within the reservoir 117 and subsequent dispersal through nozzle 140. Extraction tube 160 is manufactured from suitable durable material such as but not limited to plastic.

The extraction tube 160, as it extends away from pump head 130, branches in to a first portion 162 and a second portion 164. First portion 162 of the extraction tube 160 extends away from pump head 130 while second portion 164 curves back toward pump head 130, such that the ends of first portion 162 and second portion 164 generally point in opposite directions.

Attached to the ends of first portion 162 and second portion 164 are valves 163 and 165 respectively. In this particularly embodiment, valves 163 and 165 are gravity actuated ball valves that operate such that when spray bottle system 100 is in the upright position gravity pulls down on the ball of valve 165 and operates to close off second portion 164, while valve 163 is in an open position leaving first portion 162 open to receive fluid during the actuation of pump head 130 (see FIG. 1). When spray bottle system 100 is in an inverted position (see FIG. 2), gravity pulls down on the ball of valve 163 and operates to close off first portion 160, while valve 165 is in an open position leaving second portion 164 open to receive fluid during the actuation of pump head 130.

Although the present embodiment of the current invention utilizes ball valves for valves 163 and 165, it is contemplated to be within the scope of this invention that various types of valves could be utilized and still maintain the functionality of the present invention herein.

Referring again to FIG. 1, the first portion 162 of the extraction tube 160 functions to extract liquid disposed within the reservoir 117 while the bottle 110 of the spray bottle system 100 is oriented such the pump head 130 is primarily above the bottle 110, i.e. an upright position. As such, to be operable in the upright position, of the first portion 162 of the extraction tube 160 must be at least partially submerged in the liquid disposed within the reservoir 117 thereby facilitating the withdrawal of the liquid from the reservoir 117.

Second portion 164 of the extraction tube 160 is integrally formed with the first portion 162. The second portion 164 of the extraction tube 160 functions to provide an egress for the liquid disposed within the reservoir 117 when the spray bottle system 100 is operated in an inverted position (see FIG. 2). In this position, the end of the second portion 164 of extraction tube 160 is at least partially submerged in the liquid disposed within the reservoir 117.

Utilizing a first portion 162 and a second portion 164 of the extraction tube 160 facilitates in assisting a user substantially extract all of the liquid disposed within the reservoir 117. It further increases the ability for a user to have the ability to substantially extract the liquid disposed within the reservoir 117 of the spray bottle system 100 regardless of the orientation of the spray bottle system 100.

Although the extraction tube 160 is illustrated in the drawings submitted herewith as having a first portion 162 and a second portion 164, it is further contemplated within the scope of the present invention that the extraction tube 160 could have a plurality of portions so as to facilitate retrieval and subsequent withdrawal of substantially all of the liquid disposed within the reservoir 117 regardless of the orientation of the spray bottle system 100.

The pump head 130 is secured to the bottle 110 proximate the end 120. The pump head 130 is manufactured from a suitable durable material such as but not limited to plastic and is releasably secured proximate the end 120 of the bottle 110 by suitable mechanical methods such as but not limited to threads. An actuating lever or trigger 150 operates a pump within pump head 130. As trigger 150 is squeezed, liquid is expelled from spray nozzle 140. As trigger 150 is released, the pump within pump head 130 draws liquid from bottle 110 up extraction tube 160. The liquid is retrieved from the reservoir from either the first portion 162 or the second portion 164 of the extraction tube 160 depending upoln the orientation of the spray bottle system 100.

The nozzle 140 is an aperture sufficient in size to facilitate the dispersal of the liquid. Those skilled in the art will recognize that numerous different sizes and shapes of nozzles 140 could be utilized to create different spray patterns as the liquid is dispersed from the spray bottle system 100.

In the preceding detailed description, reference has been made to the accompanying drawing that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A spray bottle system operable to dispense liquid, said spray bottle system comprising:
a reservoir, said reservoir configured to receive and store a liquid;
a pump head removably connected to said reservoir, said pump head operable to extract liquid from said reservoir and dispense the liquid therefrom;
an extraction tube having a first end connected to pump head, said extract tube having a second end disposed within said reservoir and a third end disposed within said reservoir;
a first valve operably connected to said second end, and a second valve operably connected to said third end, wherein said first and second valves and said second and third ends are configured such that said pump head is operable when the spray bottle system is in at least one of an upright position and an inverted position.

2. The spray bottle system as recited in claim 1, wherein said first valve is a ball valve.

3. The spray bottle system as recited in claim 1, wherein said second valve is a ball valve.

4. The spray bottle system as recited in claim 1, wherein each of said first valve and said second valve are ball valves.

5. The spray bottle system as recited in claim 4, wherein said pump head includes a nozzle.

6. The spray bottle system as recited in claim 5, wherein said pump head includes a trigger for actuating said pump head.

7. The spray bottle system as recited in claim 6, wherein said first valve and said second valve are each operable between an open and a closed position, and wherein when the spray bottle system is in the upright position the first valve is in the open position and the second valve is in the closed position, and further wherein when the spray bottle system is in the inverted position the first valve is in the closed position and the second valve position is in the open position.

8. A pump bottle configured to dispense a liquid contained therein when the bottle is in at least one of an inverted position and an upright position, said pump bottle comprising:
a reservoir, said reservoir having an opening, said reservoir configured to receive and store a liquid therein;
a pump head connected to said reservoir, said pump head operable to dispense liquid; and
an extraction tube, said extraction tube having a first end connected to said pump head, a first extraction end positioned within said reservoir distal said opening of said reservoir and operable to extract the liquid when the pump bottle is in the upright position, and a second extraction end positioned within said reservoir proximate said opening of said reservoir and operable to extract the liquid when the pump bottle is in the inverted position.

9. The pump bottle as recited in claim 8, and further including a valve system connected to said extraction tube.

10. The pump bottle as recited in claim 9, wherein said valve system includes a first valve connected to said first extraction end of said extraction tube.

11. The pump bottle as recited in claim 10, wherein said valve system includes a second valve connected to said second extraction end of said extraction tube.

12. The pump bottle as recited in claim 1 1, wherein each of said first valve and said second valve are ball valves.

13. The pump bottle as recited in claim 12, wherein said first valve and said second valve are each operable between an open and a closed position, and wherein when the pump bottle is in the upright position the first valve is in the open position and the second valve is in the closed position, and further wherein when the spray bottle system is in the inverted position the first valve is in the close position and the second valve position is in the open position.

14. The pump bottle as recited in claim 13, wherein said pump head includes a trigger for actuating said pump head.

15. A device operable to dispense a liquid when the device is positioned in at least one of an upright position and an inverted position, said device comprising:
a reservoir, said reservoir having an opening, said reservoir configured to receive and store the liquid therein;
a pump head connected to said reservoir, said pump head operable to dispense liquid; and
an extraction tube, said extraction tube having a first end connected to said pump head, a first extraction end positioned within said reservoir distal said opening of said reservoir and operable to extract the liquid when the pump bottle is in the upright position, and a second extraction end positioned within said reservoir proximate said opening of said reservoir and operable to extract the liquid when the pump bottle is in the inverted position.

16. The device as recited in claim 15, and further including a valve system connected to said extraction tube, said valve system includes a first valve connected to said first extraction end of said extraction tube.

17. The device as recited in claim 16, wherein said valve system includes a second valve connected to said second extraction end of said extraction tube.

18. The device as recited in claim 17, wherein each of said first valve and said second valve are ball valves.

19. The device as recited in claim 18, wherein said first valve and said second valve are each operable between an open and a closed position, and wherein when the pump bottle is in the upright position the first valve is in the open position and the second valve is in the closed position, and further wherein when the spray bottle system is in the inverted position the first valve is in the close position and the second valve position is in the open position.

20. The device as recited in claim 19, wherein said pump head includes a trigger for actuating said pump head.
